(19) United States
(12) Patent Application Publication
(10) Pub. No.: US 2006/0222277 A1
(43) Pub. Date: Oct. 5, 2006

(54) Spherical bearing arrangement

(76) Inventors: Paul Raymond Smith, Lincoln (GB); Allen Christopher Clarke, Lincoln (GB)

Correspondence Address: KLARQUIST SPARKMAN, LLP, 121 SW SALMON STREET, SUITE 1600, PORTLAND, OR, 97204, US

(21) Appl. No.: 10/549,658

(22) PCT Filed: Mar. 25, 2004
(86) PCT No.: PCT/GB04/01298

§ 371 Date: Sep. 16, 2005

(30) Foreign Application Priority Data
Mar. 31, 2003 (GB) 0307424.2

(51) Int. Cl. F16C 23/04

(52) U.S. Cl. 384/192

(57) ABSTRACT

A bearing arrangement comprising a spherical bearing having a bearing housing and a ball located therein, the bearing housing having a rigid outer race and a rigid inner race an annular elastomeric portion sandwiched between the races, wherein the outer race of the bearing housing is securely held in an interference fit hole.

This invention relates to a bearing arrangement and more particularly to high torque applications for spherical bearings.

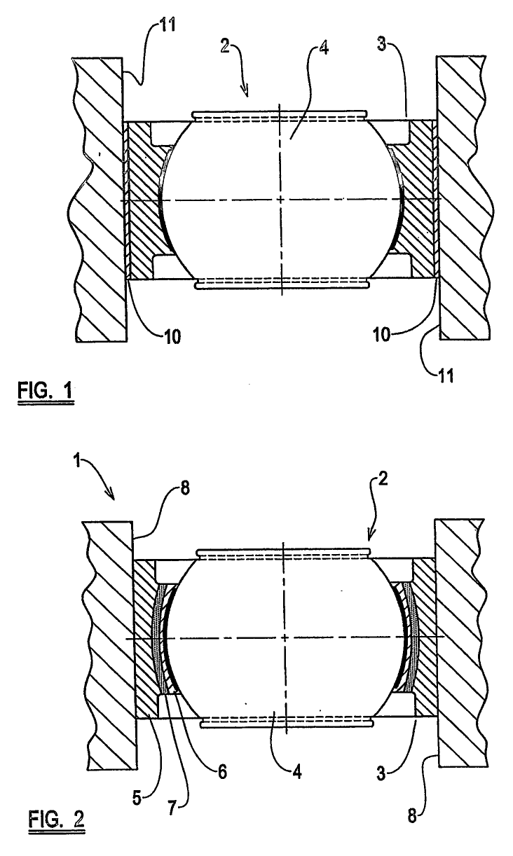

Spherical bearings are often used in high torque applications where a pre-determined torque must be retained when a bearing is installed into a hole to provide a bearing function between two parts. Whilst it is preferred practice to have a degree of interference between the spherical bearing and the hole into which it is installed, the use of an interference fit hole causes the torque of the bearing to be increased considerably from its pre-installation torque, simply because the interference fit deforms the bearing housing effectively clamping the bearing housing down on to the ball. This is unfortunate because the more interference provided between the bearing and the hole, the more securely the bearing will be installed and held within the hole. Unfortunately, if the torque of the bearing arrangement in the interference hole is outside the tolerances specified for the application, the torque having been increased when inserted into the interference fit hole, then this arrangement can simply not be used. Accordingly, the conventional practice is to use a clearance fit hole into which the spherical bearing is inserted. The bearing housing is secured to the clearance fit hole by an adhesive. FIG. 1 of the accompanying drawings shows a bearing arrangement in which a spherical bearing is installed in a clearance fit hole and secured therein by a layer of adhesive between the clearance fit hole and the outer surface of the bearing housing. This method ensures that the torque does not appreciably change during assembly so that the measured torque of the bearing, prior to installation, remains substantially unaltered after installation.

However, it should be noted that the bearing is only as secure in the clearance fit hole as the strength of the adhesive allows. Typically, the adhesives used in these applications are brittle and their strength can reduce over time, leading to the possibility of movement between the bearing housing and the clearance fit hole as the adhesive layer degenerates. Typically, the clearance fit hole is located in an expensive or precision machined part of an overall apparatus and damage will be caused to the clearance fit hole and possibly other areas of the product as a result of movement of the bearing housing within the clearance fit hole. Thus, when the bearing needs replacing because it too may also be damaged because of its movement between the bearing housing and the clearance fit hole, the clearance fit hole is now oversize so the clearance fit hole needs to be re-bored—if that is possible—or the apparatus scrapped. In the case that the clearance fit hole can be re-bored, it would then be necessary to supply an oversize bearing housing—a one-off and expensive process.

It is an object of the present invention to provide a bearing arrangement which does not require the use of a clearance fit hole to maintain the torque of a bearing in an acceptable range after installation.

Accordingly, one aspect of the present invention provides a spherical bearing having a bearing housing and a ball located therein, the bearing housing having a rigid outer race, a rigid inner race and an annular elastomeric portion sandwiched between the races, wherein the outer race of the bearing housing is securely held in an interference fit hole.

In order that the present invention may be more readily understood, embodiments thereof will now be described, by way of example, with reference to the accompanying drawings, in which:

FIG. 1 is a schematic cross-section of a bearing arrangement not in accordance with the present invention installed in a clearance fit hole; and

FIG. 2 is a bearing arrangement embodying the present invention installed in an interference fit hole.

Referring now to FIG. 2 of the drawings, a bearing arrangement 1 embodying the present invention is shown and comprises a spherical bearing 2 having a bearing housing 3 and a ball 4 located therein, the bearing housing 2 having a rigid steel outer race 5 and a rigid steel inner race 6 between which is sandwiched an annular elastomeric portion 7, in this example, a rubber sleeve bonded to both races 5,6. The outer race 5 of the bearing housing is securely held in an interference fit hole 8 (being an interference fit hole because the internal diameter of the hole 8 is less than the outer diameter of the outer race 5). It will be noted that there is no gap between the outer surface of the outer race 5 of the bearing housing 3 and the interference fit hole 8. This is in contrast to the conventional arrangement shown in FIG. 1 in which a layer of adhesive 10 bonds the bearing housing to the clearance fit hole 11—like numerals being used to denote like parts.

Preferably, a self-lubricating liner 12 is provided on the inner surface of the inner race 6 in contact with the ball 4. Alternatively, the inner race 6 and ball 4 may be in direct contact with one another.

If a conventional bearing such as that shown in FIG. 1 were installed in an interference fit hole 8, then an increase in the torque between the ball 4 and the housing 3 would be observed. Increases in torque for low torque applications are not of great concern but for high torque applications where it is a requirement that torque be maintained with a predetermined range but at a high level, the use of an interference fit hole 8 dramatically increases the torque usually outside the acceptable range for that high torque application. This is because there is an almost exponential relationship between torque and the amount of interference at high torque (5 to 100 Nm) applications. In some high torque applications (8 to 50 Na), it is critical to maintain the high torque within a pre-determined range.

The spherical bearing 2 is installed in the interference fit hole 8 by heating the material defining the hole 8, typically a steel block to, for example, 200° C. and by cooling the spherical bearing 2 by immersion in liquid nitrogen, typically −196° C., inserting the spherical bearing 2 into the interference fit hole 8 and allowing the temperatures of the two parts to return to ambient. Tests were undertaken to ascertain whether there had been an increase in oscillatory torque after installation but for torques ranging from 1 Nm to 32 Nm, there was no change whatsoever in the measured oscillatory torque after installation compared to that before installation. It seems that the use of an annular elastomeric portion 7 sandwiched between the two races 5,6 of the bearing housing 3 serves to absorb the interference which is not, therefore, transmitted to the interface between the ball 4 and the bearing housing 3.

An additional advantage of the bearing arrangement 1 using an interference fit hole for installation is that the bearing 2 is very securely held in the interference fit hole 8 and requires a high axial load to remove it from the hole.

Interference fits in the range of 0.033 mm to 0.198 mm were used for bearings 2 having an outer diameter (i.e. the outer diameter of the outer race 5 of the bearing housing 3) of 66.736 mm to 66.782 mm. No increase in oscillatory torque values was noted after installation with these interference fits.

Not only does the interference fit installation of the spherical bearing 2 maintain torque within predetermined ranges in high torque applications but also the technique is far simpler than the adhesive method of assembly using a clearance fit hole which requires stringent cleanliness. Further, there is the advantage that of the risk of damage being caused to the installation hole by relative movement with the spherical bearing due to a breakdown of a securing adhesive between bearing 2 and clearance fit hole 11 is totally eliminated by the present invention.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A bearing arrangement comprising a spherical bearing having a bearing housing and a ball located therein, the bearing housing having a rigid outer race and a rigid inner race and an annular elastomeric portion sandwiched between the races, wherein the outer race of the bearing housing is securely held in an interference fit hole and the arrangement has a torque between the ball and housing within a predetermined range prior to being installed in the interference fit hole, the torque remaining within the predetermined range when held in the interference fit hole.

2. A bearing arrangement according to claim 1, wherein the spherical bearing is a high torque bearing having an oscillatory torque in the range of about 5 to about 100 Nm prior to insertion in the interference fit hole.

3. A bearing arrangement according to claim 2, wherein the spherical bearing is a high torque bearing having an oscillatory torque in the range of about 8 to about 50 Nm prior to insertion in the interference fit hole.

4. A bearing arrangement according to claim 1, wherein the elastomeric portion is bonded to the inner and outer races.

5. A bearing arrangement according to claim 1, wherein a liner is provided on the inner race in contact with the ball.

6. A bearing arrangement according to claim 5, wherein the liner is a self-lubricating liner.

7. A bearing arrangement according to claim 1, wherein the inner race and ball are both manufactured from metal and the inner race is in direct contact with the ball.

8. (canceled)

9. A bearing arrangement according to claim 2, wherein a liner is provided on the inner race in contact with the ball.

10. A bearing arrangement according to claim 9, wherein the liner is a self-lubricating liner.

11. A bearing arrangement according to claim 2, wherein the inner race and ball are both manufactured from metal and the inner race is in direct contact with the ball.

12. A bearing arrangement according to claim 3, wherein a liner is provided on the inner race in contact with the ball.

13. A bearing arrangement according to claim 12, wherein the liner is a self-lubricating liner.

14. A bearing arrangement according to claim 3, wherein the inner race and ball are both manufactured from metal and the inner race is in direct contact with the ball.

15. A bearing arrangement according to claim 4, wherein a liner is provided on the inner race in contact with the ball.

16. A bearing arrangement according to claim 4, wherein the inner race and ball are both manufactured from metal and the inner race is in direct contact with the ball.
